(19) United States
(12) Patent Application Publication
(10) Pub. No.: US 2014/0124040 A1
(43) Pub. Date: May 8, 2014

(54) Bucket Sump

(71) Applicant: Jerry L. Baggett, JR., Covington, LA (US)

(72) Inventor: Jerry L. Baggett, JR., Covington, LA (US)

(21) Appl. No.: 13/669,835

(22) Filed: Nov. 6, 2012

(51) Int. Cl. B65D 6/40; F16L 55/00; B05B 9/03

(52) U.S. Cl. 137/15.01; 239/302; 220/601

(57) ABSTRACT

A bucket sump system for use with a liquid which includes a bucket having an interior comprising: sides defining an open top and coupled to a flat bottom, and a wedge insert received by the interior of the bucket, resting flush against the flat bottom of the bucket. The wedge insert has a flat bottom portion, a sloped top surface connected to the bottom portion through a first side having a first height and a second side having a second height, and an orifice defined by the first side of the wedge insert. The liquid received by the interior of the bucket flows from the second side of the sloped top portion of the wedge insert to the first side of the sloped top portion of the wedge insert and into the orifice. The second height of the wedge insert is greater than the first height of the wedge insert.

### BACKGROUND OF THE INVENTION

1. Field of the Invention

The invention pertains to the field of sumps. More particularly, the invention pertains to a gravity flow sump system using a bucket.

2. Description of Related Art

Many people use paint sprayers as an efficient way to paint or stain a significant area in a small amount of time using the least amount of paint. Often, paint sprayers are coupled to flat bottomed containers in which paint is drawn for spraying through the paint sprayer. In order to use the most liquid within the container, a user has to prop and tilt the container in order get the dregs of the liquid out. Due to the tilt and propping of the container when attempting to access the remaining dregs of the liquid, suction from the strainer remains above the liquid, resulting in waste of the liquid. Therefore, flat bottomed containers waste a significant amount of liquid intended for spraying.

U.S. Pat. No. 6,047,846 and related U.S. Pat. No. 6,223,930, both entitled, “Plastic Drum With Drain Sump”, disclose a plastic drum in which the bottom of the drum is formed with a sump, which is vertically aligned with an access hole. The drums of these patents do not provide a means for a user to attach and adapt the drum for use with an airless sprayer, nor do they include a liner or a wedge insert which can convert any bucket or container into a sump.

### SUMMARY OF THE INVENTION

A bucket sump system for use with a liquid which includes a bucket having an interior comprising: sides defining an open top and coupled to a flat bottom, and a wedge insert received by the interior of the bucket, resting flush against the flat bottom of the bucket. The wedge insert has a flat bottom portion, a sloped top surface connected to the bottom portion through a first side having a first height and a second side having a second height, and an orifice defined by the first side of the wedge insert. The liquid received by the interior of the bucket flows from the second side of the sloped top portion of the wedge insert to the first side of the sloped top portion of the wedge insert and into the orifice. The second height of the wedge insert is greater than the first height of the wedge insert.

### BRIEF DESCRIPTION OF THE DRAWINGS

FIG. 1 shows an exploded view of a bucket sump of an embodiment of the present invention.

FIG. 2 shows a schematic of a bucket sump of an embodiment of the present invention.

FIG. 3 shows a schematic of a bucket sump coupled to an airless paint sprayer.

FIG. 4 shows a schematic of a bucket sump of an alternate embodiment.

FIG. 5 shows a close up view of the airless suction tube with an attached airless suction screen received by the orifice of the wedge insert of an embodiment of the present invention.

### DETAILED DESCRIPTION OF THE INVENTION

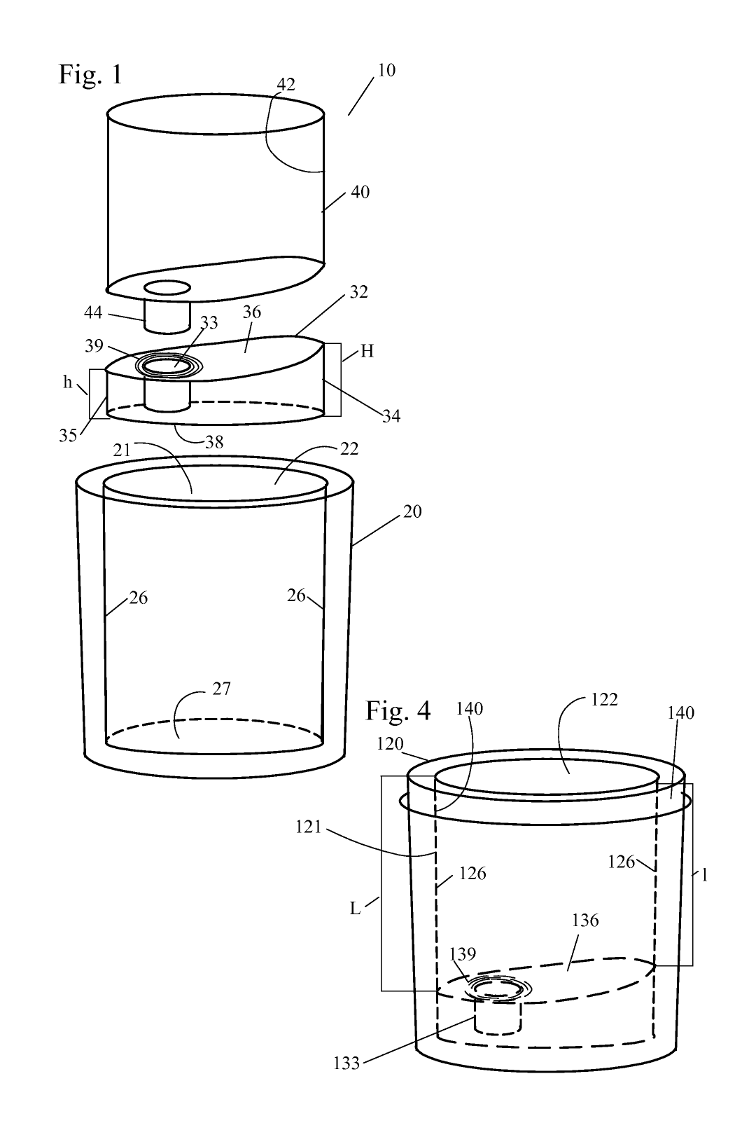

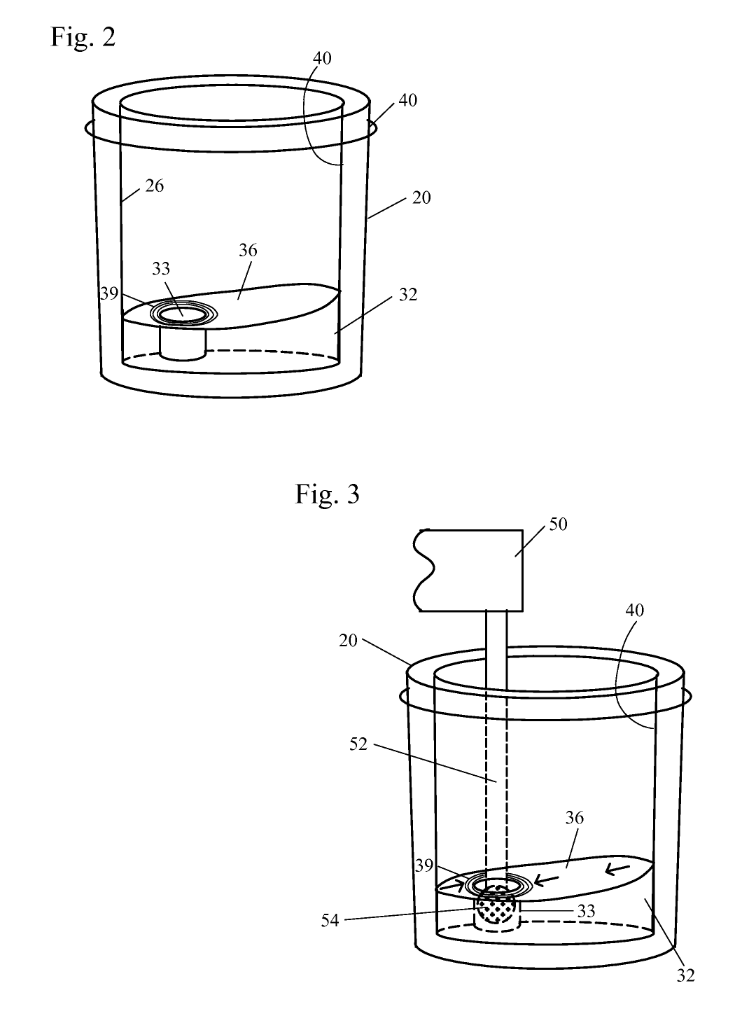

FIG. 1 shows an exploded view of a bucket sump in an embodiment of the present invention. In this embodiment, the bucket sump 10 may be created by converting a flat bottomed container or bucket by inserting a wedge insert 32 and a bucket liner 40 into an interior of the bucket, converting the flat bottomed bucket into a gravity flow sump system that may, for example, be used with an airless paint sprayer. FIG. 2 shows the bucket sump assembled.

The container or bucket 20 has an interior 21 with an open top 22, sides 26 and a flat bottom 27. The interior 21 of the bucket 20 receives the wedge insert 32. The wedge insert 32 has a flat bottom 38 which, when inserted into the bucket 20, lies flush and adjacent to the bottom 27 of the bucket 20 as well as flush with the sides 26. The top surface 36 of the wedge insert 32 is sloped or graduated such that the height H of one side 34 of the wedge insert 32 is greater than the height h of the other side 35 of the wedge insert 32. Near the side 35 of the wedge insert with height h is an orifice or bore 33. The orifice 33 is preferably of sufficient size and depth to accommodate an airless suction screen 54 as shown in FIG. 3. The size of the orifice 33 may vary based on the depth and diameter needed to accommodate different sized suction screens. The slope or graduation of the top surface 36 of the wedge insert 32 allows for any liquid placed in the bucket 20 to flow towards the orifice 33 via gravity. In a preferred embodiment, the wedge insert 32 has some additional sloping 39 near the orifice forms a depression that also ensures that any liquid placed in the bucket 20 flows into the orifice 33 via gravity. The wedge insert 32 is reinforced to support the weight of the liquid to be placed in the bucket 20. It should be noted that the wedge insert 32 fills substantially all of the interior area of the container.

A liner 40 within an interior 42 is preferably received by the interior 21 of the bucket 20 and lines the sides 26 of the bucket 20, and the sloped top surface 36 of the wedge insert 32. The liner 40 is preferably larger than the bucket 20, such that a portion of the liner 40 may wrap around or contact the outer sides of the bucket as shown in FIG. 2, ensuring that no liquid can get between the liner 40 and the outer sides of the bucket. The liner 40 is preferably of a material that conforms to the interior 21 of the bucket 20 and the slope or graduated top surface 36 of the wedge insert 32 and can be easily replaceable and/or cleanable. The liner 40 also preferably has a cup section 44 that is received by the orifice 33 of the wedge insert 32.

In an alternate embodiment, the wedge insert 32 may be integrally formed with the container or bucket 120 as shown in FIG. 4. The container or bucket 120 has an interior 121 with an open top 122, sides 126 and a sloped or graduated surface bottom 136 such that the length L of one of the sides of the bucket is longer than the length l of the other side of the bucket. Near the side with the longer length L is an orifice 133. The orifice 133 is preferably of sufficient size and depth to accommodate an airless suction screen 54 similar to the airless suction screen shown in FIG. 3. The size of the orifice 133 may vary based on the depth and diameter needed to accommodate different sized suction screens. The slope or graduation of the bottom 136 of the bucket 120 allows for any liquid placed in the bucket 120 to flow towards the orifice 133 via gravity. In a preferred embodiment, the bottom 136 of the bucket has some additional sloping 139 near the orifice forms a depression that also ensures that any liquid placed in the bucket 20 flows into the orifice 133 via gravity.

A liner 140 is preferably received by the interior 121 of the bucket 120 and lines the sides 126 of the bucket 120 and the sloped bottom surface 136 of the bucket 120. The liner 140 is preferably larger than the bucket 20, such that a portion of the liner 140 may wrap around or contact the outer sides of the bucket as shown in FIG. 4, ensuring that no liquid can get between the liner 140 and the outer sides of the bucket. The liner 140 is preferably of a material that conforms to the interior 121 of the bucket 120 and the sloped or graduated bottom 136 and can be easily replaceable and/or cleanable. The liner 140 also preferably has a cup section that is received by the orifice 133 of the bottom of the bucket 120.

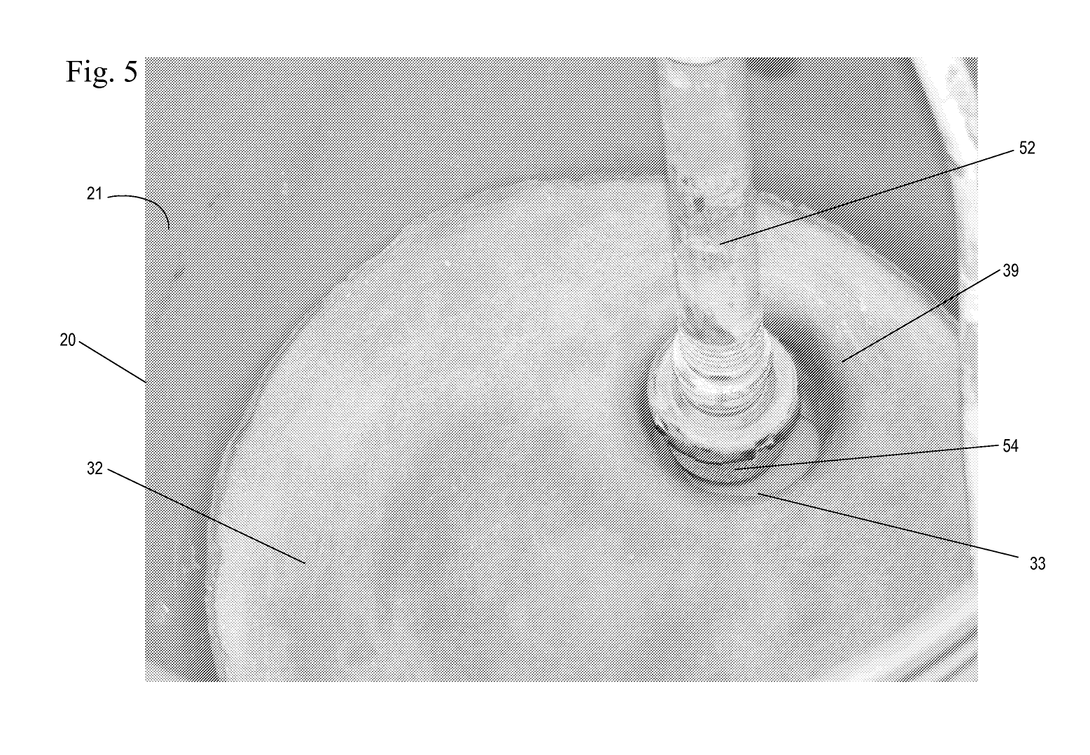

FIG. 3 shows the bucket sump in an embodiment of the present invention coupled to an airless paint sprayer. To use the paint sprayer 50 with the bucket sump, the wedge insert 32 is inserted within a flat bottom bucket 20. It should be noted that this step is unnecessary if the wedge insert 32 and the bucket 20 are integrally formed and are one piece, in other words, the bucket has a sloped or graduated surface 136 as shown in FIG. 4. A liner 40, 140 is then inserted into the interior 21, 121 of the bucket 20, 120 and placed into contact with the sides of the bucket, the top surface 36 of the wedge insert 32 (or the sloped surface 136 of the bottom of the bucket 120), the orifice 33 of the wedge insert 32 (or the orifice 133 of the bottom of the bucket 120), and hangs or wraps around the outer sides of the bucket. An airless suction tube 52 with an attached airless suction screen 54 is placed within the lined orifice 33. A liquid is then placed into the interior of the lined bucket 20, 120 and the airless suction tube 52 is coupled to the airless sprayer 50. FIG. 5 shows a close up view of the airless suction tube 52 with an attached airless suction screen 54 received by the orifice 33 of the wedge insert 32. By using the sloped or graduated wedge insert 32 or a sloped bottom 136 in the bucket 20, 120, any liquid placed in the bucket flows towards the orifice 33, 133 via gravity and thus the amount of liquid wasted is significantly reduced from using just a flat bottomed bucket or container and the chance of spilling the liquid is also reduced since the container or bucket does not need to be propped up or tilted to attempt to use all of the liquid within the container or bucket.

The bucket is not limited to the shape or dimensions shown in the drawings.

The liquid may be acrylic based, oil based, paint, water based, latex, acrylic latex, enamel, rubber based, roof coating, water, oil, or cleaning solutions and solvents.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A bucket sump system for use with a liquid comprising:
a bucket having an interior comprising sides defining an open top and coupled to a flat bottom; and
a wedge insert received by the interior of the bucket, resting flush against the flat bottom of the bucket, the wedge insert comprising:
a flat bottom portion;
a sloped top surface connected to the bottom portion through a first side having a first height and a second side having a second height;
an orifice defined by the first side of the wedge insert; and
a sloped depression surrounding the orifice;
wherein the second height of the wedge insert is greater than the first height of the wedge insert; and
wherein the liquid received by the interior of the bucket flows from the second side of the sloped top portion of the wedge insert to the first side of the sloped top portion of the wedge insert, through the sloped depression and into the orifice.

2. The bucket sump system of claim 1, further comprising a liner received by the interior of the bucket, lining the sides of the bucket, the orifice of the wedge insert, the sloped top surface of the wedge insert, and at least a portion of an outer side of the bucket.

3. The bucket sump system of claim 1, further comprising an airless suction tube with a first end connected to an airless sprayer and a second end connected to an airless suction screen, the airless suction tube received by the interior of the bucket and the airless suction screen received by the orifice of the wedge insert.

4. The bucket sump system of claim 1, wherein the liquid is selected from the group consisting of an acrylic based liquid, an oil based liquid, a water based liquid, a latex based liquid, an acrylic latex based liquid, an enamel based liquid, a rubber based liquid, roof coating, water, oil, and cleaning solutions and solvents.

5. A method of using an airless liquid sprayer coupled to a bucket sump system comprising the steps of:
a) inserting a liner into the bucket sump, the bucket sump comprising: a bucket having an interior comprising sides defining an open top and coupled to a flat bottom;
and a wedge insert received by the interior of the bucket, resting flush against the flat bottom of the bucket, the wedge insert comprising: a flat bottom portion; a sloped top surface connected to the bottom portion through a first side having a first height and a second side having a second height; an orifice defined by the first side of the wedge insert; and a sloped depression surrounding the orifice;
b) placing an airless suction tube with a first end connected to an airless sprayer and a second end connected to an airless suction screen into the interior of the bucket, such that the airless suction screen is received within the orifice of the wedge insert; and
c) adding liquid to the bucket.

6. The method of claim 5, further comprising, prior to step a), the step of inserting a wedge insert into the bucket such that the flat bottom portion of the wedge insert is adjacent the flat bottom of the bucket.

7. The method of claim 5, wherein the liquid is selected from the group consisting of an acrylic based liquid, an oil based liquid, a water based liquid, a latex based liquid, an acrylic latex based liquid, an enamel based liquid, a rubber based liquid, roof coating, water, oil, and cleaning solutions and solvents.

8. A bucket for a sump system for use with a liquid comprising:
an open top; and
an interior comprising:
a plurality of sides;
a sloped bottom connected to the sides through a side having a first length and another side having a second length, wherein the first length is longer than the second length; and an orifice formed by the sloped bottom adjacent the side having the first length;
an orifice defined by the sloped bottom; and
a sloped depression on the sloped bottom and surrounding the orifice.

9. The bucket of claim 8, further comprising a liner received by the interior of the bucket, lining the sides of the bucket, the orifice of the bottom, the sloped bottom and at least a portion of an outer side of the bucket.

10. The bucket of claim 8, further comprising an airless suction tube with a first end connected to an airless sprayer and a second end connected to an airless suction screen, the airless suction tube received by the interior of the bucket and the airless suction screen received by the orifice of the sloped bottom.

11. The bucket of claim 8, wherein the liquid is selected from the group consisting of an acrylic based liquid, an oil based liquid, a water based liquid, a latex based liquid, an acrylic latex based liquid, an enamel based liquid, a rubber based liquid, roof coating, water, oil, and cleaning solutions and solvents.
